(19) United States
(12) Patent Application Publication
(10) Pub. No.: US 2005/0155755 A1
(43) Pub. Date: Jul. 21, 2005

(54) Liquid cooling device and electronic equipment provided with the same

(75) Inventors: Toshihiko Matsuda, Fukuoka-shi (JP); Kyo Niwatsukino, Fukuoka-shi (JP); Shinya Koga, Omuta-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/018,413

(22) Filed: Dec. 22, 2004

(30) Foreign Application Priority Data
Dec. 25, 2003 (JP) P2003-429465

(51) Int. Cl. F28D 15/00; G05D 9/00; F25B 49/00; G05D 23/00; F25B 41/00; F28F 27/00

(52) U.S. Cl. 165/301; 165/287; 165/104.31; 165/104.33

(57) ABSTRACT

A liquid cooling device according to the invention is based upon a liquid cooling device for a computer in which a cooler, a radiator, a pump and a reserve tank for reserving a refrigerant are provided to a closed circulating passage for circulating the refrigerant, the pump operating at a predetermined revolution circulates the refrigerant, the cooler removes heat from CPU using the refrigerant and the radiator radiates the removed heat, and is mainly characterized in that judgment means that judges that the operation is to be continued in case the revolution of the pump is equal to or smaller than the set revolution and judges that the quantity of the refrigerant is insufficient in case the revolution of the pump exceeds the set revolution is provided.

This application is based on Japanese Patent Application No. 2003-429465, which is incorporated herein by reference.

### BACKGROUND OF THE INVENTION

1. Field of the Invention

The present invention relates to a liquid cooling device for cooling an exothermic component such as a central processing unit (hereinafter called CPU) formed by a semiconductor integrated circuit by circulating a refrigerant and electronic equipment in which it is mounted.

2. Description of the Related Art

The movement of speedup in a recent computer is extremely rapid and a clock frequency of CPU is greatly increased, compared with that of a conventional type. As a result, the calorific value of CPU is increased, the cooling power is short in case CPU is cooled by a heat sink as heretofore and a liquid cooling device the efficiency of which is satisfactory and which has high output is indispensable. Then, for such a liquid cooling device, a liquid cooling device in which a refrigerant is circulated on a substrate on which an exothermic component is mounted is proposed (refer to JP-A-8-32263)

Such a liquid cooling device for cooling by circulating the refrigerant of conventional type electronic equipment will be described below. Electronic equipment in this specification includes a device in which programs are loaded onto CPU and others for executing processing, above all a portable small-sized computer such as a notebook-sized personal computer. In addition, the electronic equipment in this specification includes a device in which an exothermic component heated by electrification is mounted and which is formed by electronic components. For the conventional type liquid cooling device, the one shown in FIG. 6 is known for example.

FIG. 6 is a block diagram showing a liquid cooling device of conventional type electronic equipment. As shown in FIG. 6, a reference number 101 denotes a body, 102 denotes an exothermic component, 103 denotes a substrate on which the exothermic component 102 is mounted, 104 denotes a cooler for cooling the exothermic component 102 by executing heat exchange between the exothermic component 102 and a refrigerant, 105 denotes a radiator for removing heat from the refrigerant, 106 denotes a pump for circulating the refrigerant, 107 denotes a reserve tank for replenishing the refrigerant, 108 denotes piping for connecting these, and 109 denotes a fan for cooling the radiator 105.

To explain the operation of the conventional type liquid cooling device, the refrigerant discharged from the pump 106 is carried to the cooler 104 through the piping 108. The temperature rises by removing the heat of the exothermic component 102 and the refrigerant is carried to the radiator 105. The refrigerant is forcedly cooled by the fan 109 in the radiator 105, the temperature falls, the refrigerant is returned to the pump 106 again and this is repeated. As described above, the exothermic component 102 is cooled by circulating the refrigerant.

However, in the conventional type liquid cooling device, when time elapses for a long term, the refrigerant is gradually lost from a connection of a wall forming a circulating passage and the piping. As a result, when the refrigerant in the reserve tank decreases and cannot be replenished from the reserve tank into the circulating passage, air is mixed in the circulating passage. When air is mixed in the refrigerant, heat capacity is deteriorated thereby the cooling power is deteriorated. Further, when a large quantity of air is mixed, the pump is locked with the air and the circulation of the refrigerant is disabled. Hence, the cooling power is lost.

### SUMMARY OF THE INVENTION

An object of the invention is to provide a liquid cooling device that detects the insufficiency of a liquid refrigerant of a liquid cooling device and avoids an overheated state by the deterioration of the cooling power of an exothermic component and electronic equipment having the same.

The invention is based upon a liquid cooling device for an electronic equipment comprising a closed circulating passage for circulating a liquid refrigerant, a pump operating at a predetermined revolution for circulating the refrigerant, a cooler removing a heat from an exothermic component using the liquid refrigerant, a radiator radiating the removed heat, and a reserve tank reserving the refrigerant, wherein a first set revolution is set to more than a revolution at which the pump is steadily operated, the liquid cooling device is judged to continue operating in case the revolution of the pump is equal to or smaller than the first set revolution, and a quantity of refrigerant is judged to be insufficient in case the revolution of the pump exceeds the first set revolution.

According to the liquid cooling device of the invention, it can be judged that the quantity of the liquid refrigerant is insufficient. Therefore, the deterioration of the cooling power by the mixing of air and the overheated state of the exothermic component can be avoided.

As the liquid cooling device according to the invention and the electronic equipment having the same are provided with the judgment means for judging that the quantity of the refrigerant is insufficient in case the revolution of the pump exceeds the set revolution. Therefore, they can judge that the quantity of the refrigerant is insufficient and can avoid the deterioration of the cooling power by the mixing of air and the overheated state of the exothermic component.

A first aspect made to solve the above-mentioned problem is based upon a liquid cooling device for electronic equipment in which a cooler, a radiator, a pump and a reserve tank for reserving a refrigerant are provided to a closed circulating passage for circulating a refrigerant, the pump circulates the refrigerant at a set revolution, the cooler removes heat from an exothermic component using the refrigerant and the radiator radiates the removed heat, and is characterized in that judgment means for judging that the operation is to be continued in case the revolution of the pump is equal to or smaller than the set revolution and judging that the quantity of the refrigerant is insufficient in case the revolution of the pump exceeds the set revolution is provided, it can be judged by the judgment means that the quantity of the refrigerant in the liquid cooling device is insufficient and the deterioration of the cooling power by the mixing of air and the overheated state of the exothermic component can be avoided.

A second aspect of the invention is based upon the first aspect and is characterized in that in case the revolution of the pump exceeds the set revolution and is included in a range of predetermined numbers of revolutions smaller than a revolution at which an air lock is caused, the judgment means judges that the quantity of the refrigerant is insufficient and the overheated state of the exothermic component can be more securely avoided.

A third aspect of the invention is based upon the first or second aspect and is characterized in that caution execution means for executing a caution process when the judgment means judges that the quantity of the refrigerant is insufficient is provided and as the caution process is executed when the judgment means judges that the quantity of the refrigerant in the liquid cooling device is insufficient, the overheated state can be securely avoided.

A forth aspect of the invention is based upon electric equipment which is capable of displaying on a display device, wherein the caution execution means instructs the display to display a caution when the judgment means judges that the quantity of the refrigerant is insufficient. When the judgment means judges that the quantity of the refrigerant in the liquid cooling device is insufficient, the caution is displayed on the electronic equipment. Thus, the overheated state can be securely avoided.

A fifth aspect of the invention is based upon electronic equipment provided with the liquid cooling device, wherein in case the judgment means judges that the quantity of the refrigerant is insufficient, the caution execution means instructs control for reducing the calorific value of the exothermic component so as to change an operation mode. When the judgment means judges that the quantity of the refrigerant in the liquid cooling device is insufficient, the caution execution means instructs the electronic equipment to control so that the calorific value of the exothermic component is inhibited. Thus, the overheated state can be securely avoided.

A sixth aspect of the invention is based upon electronic equipment, wherein the exothermic component is a semiconductor integrated circuit, and the control

A sixth aspect of the invention is based upon electric equipment, wherein the exothermic component is a semiconductor integrated circuit, and the control for reducing the calorific value is control for reducing an operating frequency of the semiconductor integrated circuit. As the operating frequency of the semiconductor integrated circuit is reduced, the calorific value can be inhibited. Therefore, an overheated state of the semiconductor integrated circuit can be securely avoided.

A seventh aspect of the invention is based upon electronic equipment provided with the liquid cooling device, wherein the power source is turned off when the judgment means judges that the quantity of the refrigerant is insufficient. As the operating frequency of the semiconductor integrated circuit is reduced, the power source of the electronic equipment can be turned off. Therefore, the overheated state can be securely avoided.

### BRIEF DESCRIPTION OF THE DRAWINGS

FIG. 1 is a perspective view showing a computer which is provided with a liquid cooling device in an embodiment of the invention and a part of which is removed;

FIG. 2 is a side view showing a radiator of the liquid cooling device in the embodiment of the invention;

FIG. 3 is a graph showing relation between the quantity of air that enters the inside of the liquid cooling device in the embodiment of the invention and the revolution of a pump;

FIG. 4 is a block diagram showing a controller of the liquid cooling device in the embodiment of the invention;

FIG. 5 is a flowchart showing a procedure executed when a refrigerant of the liquid cooling device in the embodiment of the invention decreases; and

FIG. 6 is a block diagram showing a liquid cooling device of conventional type electronic equipment.

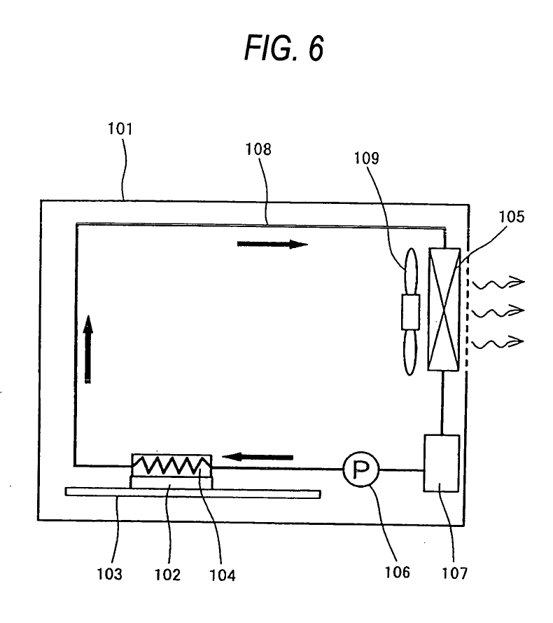

### DETAILED DESCRIPTION OF THE PREFERRED EMBODIMENTS

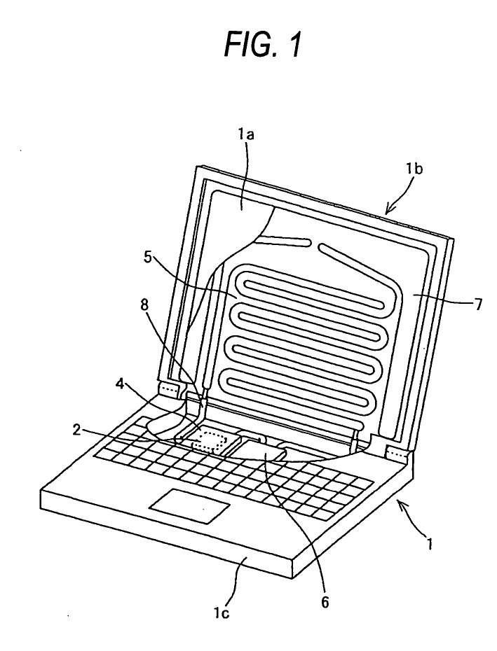

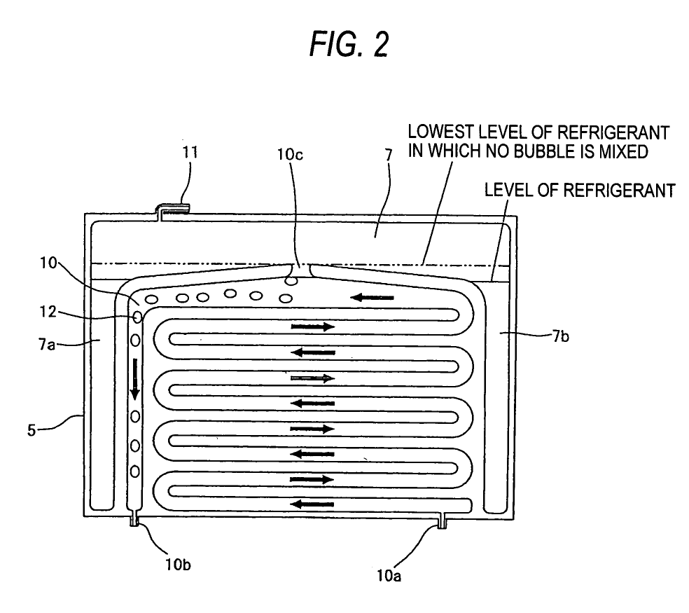

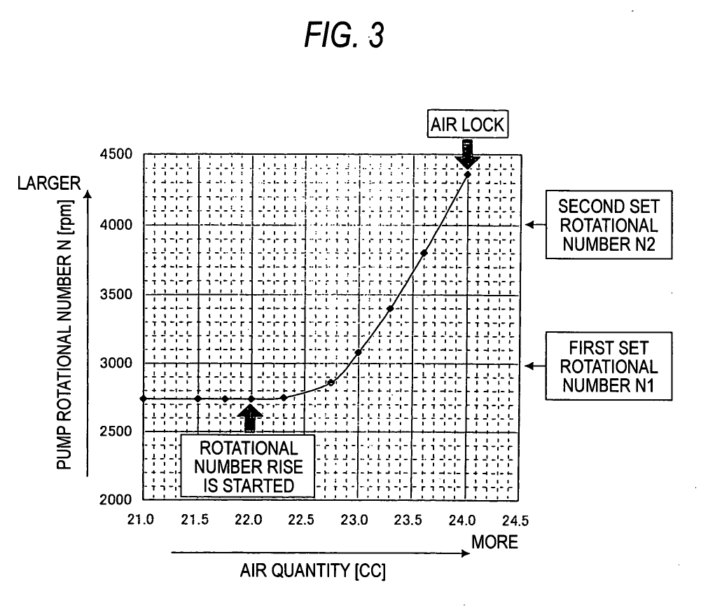

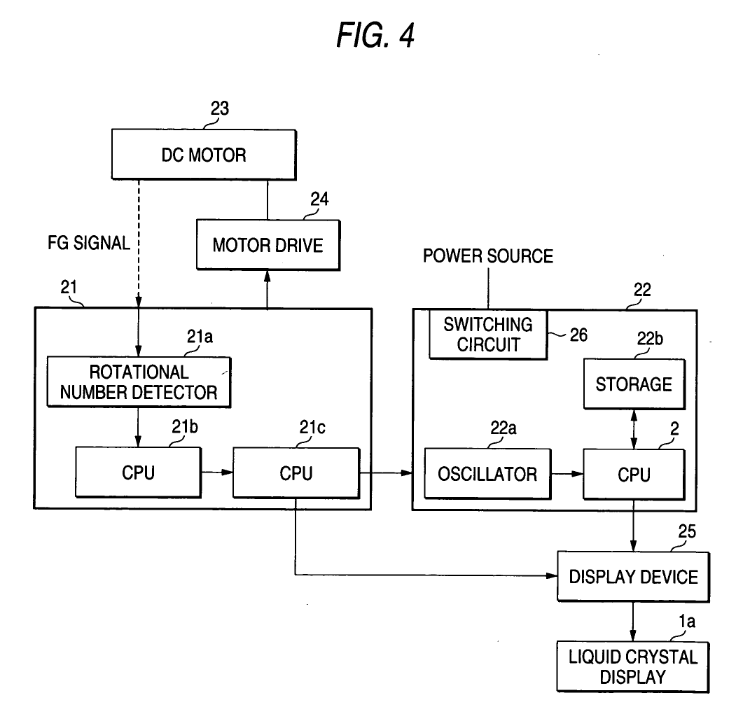

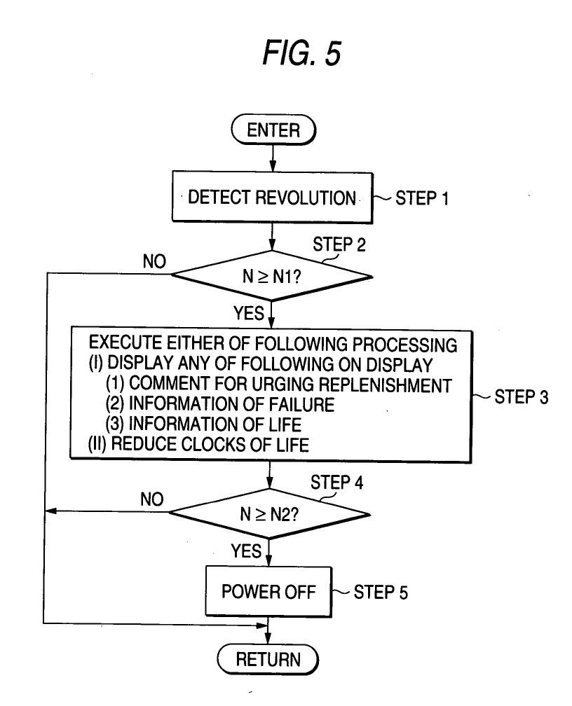

An embodiment of the invention relates to a computer as electronic equipment, particularly relates to a collapsible notebook-sized computer, and further relates to a liquid cooling device mounted in this computer. FIG. 1 is a perspective view in which a part of the computer provided with the liquid cooling device of the invention is removed, FIG. 2 is a side view showing a radiator of the liquid cooling device of the invention, FIG. 3 is a graph showing relation between air quantity in the inside of the liquid cooling device in the embodiment of the invention and the revolution of a pump, FIG. 4 is a block diagram showing a controller for the liquid cooling device in the embodiment of the invention, and FIG. 5 is a flowchart showing a procedure taken when refrigerant liquid of the liquid cooling device in the embodiment of the invention decreases.

As shown in FIG. 1, a reference number 1 denotes a body of the clamshell notebook computer; la denotes a liquid crystal display for displaying a character, a graphic and others; 1b denotes a cover on which the liquid crystal display 1a is provided; 1c denotes the body covering a keyboard provided to the body; 2 denotes CPU that is one of exothermic components of this computer and controls the computer; and 3 denotes a substrate on which CPU 2 is mounted. CPU 2 mounted in this computer generates heat in proportion to a clock frequency for operation. Recently, a computer operated with a high frequency of 1 GHz to 3 GHz is released. Such computer has extremely large calorific value. However, at the same time, the computer is required to be compact to ensure the portability. Thus, heat is easily confined in the computer.

A reference number 4 denotes a cooler for exchanging heat between CPU 2 and a refrigerant thereby cooling CPU 2, 5 denotes a radiator comprising a metallic plate which satisfies the thermal conductivity such as aluminum and stainless steel for removing heat from the refrigerant, 6 denotes a pump for circulating the refrigerant, 7 denotes a reserve tank for reserving a liquid refrigerant and for preventing the outflow of bubbles though the reserve tank allows the inflow of the bubbles even if the bubbles are mixed in a meandering passage for outgoing radiation 10 described later, 7a denotes a first extended reserve tank that surrounds the meandering passage for outgoing radiation 10 from its circumference in the reserve tank 7, 7b denotes a second extended reserve tank that surrounds the meandering passage for outgoing radiation 10 from its circumference in the reserve tank 7, and 8 denotes flexible piping that connects these and forms a circulating passage. in the inside of the cooler 4, a passage of the refrigerant is formed and heat generated in CPU 2 is transmitted to the low-temperature refrigerant via the cooler 4 which is in contact with CPU 2 in their surfaces. The radiator 5 is provided on the back side of the liquid crystal display 1a and radiates heat from the outside face of the cover 1b. It is desirable that the refrigerant is non-freezing solution such as propylene glycol aqueous solution and ethylene glycol aqueous solution to avoid the failure of the liquid cooling device in a cold district and by freezing in winter.

The pump 6 in the embodiment is a turbopump such as a centrifugal pump and a vortex pump though the pumps are not shown in the drawing, for the data of the pump, the thickness is 3 to 50 mm, the typical dimension in its radial direction is 10 to 70 mm, the revolution per minute is 600 to 4000 rpm, the flow rate is 0.01 to 1.5 L per minute, the head is 0.1 to 2 m, the specific speed is 12 to 200 (unit: m, m³ per minute, rpm.), and the pump 6 is extremely small-sized. In the liquid cooling device in the embodiment, the pump 6 is driven at a predetermined revolution set between 600 rpm. and 4000 rpm. and the refrigerant of a predetermined flow rate discharged from the pump 6 reaches the cooler 4 via the piping 8. In the cooler, the temperature rises because the refrigerant removes heat from CPU 2 and the refrigerant is delivered to the radiator 5. In the radiator 5, the heat is radiated from the outside face of the cover 1b having large area so that the temperature of the refrigerant drops. The refrigerant is then returned to the pump 6 again. In such way, the circulation is repeated.

Next, the radiator 5 in the embodiment will be described referring to FIG. 2. As shown in FIG. 2, a reference number 10 denotes the meandering passage for outgoing radiation forming the radiator 5 which is meandered to increase the area of outgoing radiation and is formed widely. The refrigerant transmits heat to the wall of the passage by passing the meandering passage for outgoing radiation 10. According thereto, the heat is radiated into the air. A reference number 10a denotes an inflow port for taking in the refrigerant connecting the meandering passage for outgoing radiation 10 and the piping 8; 10b denotes an outflow port for outflowing the refrigerant connecting the meandering passage for outgoing radiation 10 and the piping 8; 10c denotes a connection port for preventing the movement in a reverse direction by hydrodynamic action though the approach of bubbles to the side of the reserve tank 7 is allowed, connecting the meandering passage for outgoing radiation 10 and the reserve tank 7; 11 denotes a joint for filling a refrigerant; and 12 denotes a bubble. The joint 11 is closed in normal operation, however, it is opened when the refrigerant is filled. The joint may be also plugged with a rubber cap and others after the refrigerant 12 is filled and a check valve may be also provided beforehand.

In the embodiment, the radiator 5, the cooler 4 and the pump 6 respectively described above are connected in series via the piping 8, the meandering passage for outgoing radiation 10 of the radiator 5 is connected to the piping 8, and as a whole, they form a closed circulating passage. Incidentally, an incoming radiational part for receiving the heat of CPU, a heater element and others can be provided to the pump so as to integrate a function of the cooler therewith, instead of using the cooler. In the conventional type liquid cooling device, in case air in a refrigerant is not completely exhausted, an air lock is caused. On the other hand, such air lock is not caused in the embodiment, even if air is left in the reserve tank 7. One reason is that dispersed minute bubbles are concentrated in one when filled air moves in the reserve tank 7, since the figure of the notebook-sized computer can be variously changed. Further, other reason is that the air and the closed circulating passage are completely separated using the connection port 10c. In addition at this time, even if the volume of the refrigerant increases because of thermal expansion, the filled air functions as a cushion, and leakage from the circulating passage and the burst of the circulating passage can be also prevented.

Incidentally, as the refrigerant is diffused from the inside wall of the piping 8 to the outside face thereby dissipated into the air, the refrigerant gradually decreases in a long term. That is, a part of the refrigerant is gasified as time elapses, and such gasified refrigerant is replaced with the air via piping 25, though the amount varies depending upon material. Thus, bubbles 12 are mixed in the refrigerant. The bubbles 12 mixed in the refrigerant are circulated together with the refrigerant. When they are reached to an enlarged part, which is formed in the peak of the meandering passage for outgoing radiation 10 in the radiator 5, they are then moved to the connection port 10c along a tapered wall of the enlarged part and then surface into the reserve tank 7 by a buoyant force. In this way, the bubbles 12 are separated into gas and liquid. Bubbles 12 which flowed into the reserve tank 7 are inhibited to flow out to the meandering passage for outgoing radiation 10 by the connection port 10c. To flow out of the connection port 10c, bubbles 12 that greatly grow in the reserve tank 7 are required to move in the connection port 10c with keeping the surface tension. In this case, since the size of the connection port 10c is small, it is closed with an air. Further, bubbles 12 which having minute shape cannot flow out of the connection port 10c because difference is made in fluid resistance depending upon a direction by the buoyancy and the shape of the passage in the vicinity of the connection port. Incidentally, it is preferable that one connection port 10c is provided.

As for such mixing of air, the following characteristic relation between the quantity of mixed air and the revolution of the pump 6 is discovered. FIG. 3 shows relation between the quantity of air inside the liquid cooling device and the revolution of the pump 6.

According to FIG. 3, when the quantity of mixed air is 22 cc, the revolution of the pump 6 is 2700 rpm. when the quantity of mixed air exceeds 22 cc, the revolution increases. When the quantity of mixed air is increased by 24 cc, the revolution is increased by 4200 rpm, and an air lock is caused in this state. That is, a state that the impellers of the pump 6 idly run and the discharge and the circulation of the refrigerant are disabled emerges. In other words, when the air lock emerges, the revolution of the pump 6 rapidly increases, the impellers idly run, no refrigerant flows, cooling effect by the liquid cooling device is lost, and CPU 2 which is an exothermic component becomes overheated. When this state continues for long time, heat from the pump 6 is also added to CPU 2 so that CPU 2 has further high temperature.

In other words, as in the liquid cooling device in the embodiment, a load is fixed in a normal state in which no air is mixed, the device has fixed cooling power if the pump 6 is operated at the set revolution. However, when air is mixed, the load varies and the revolution varies. Furthermore, when an air lock is caused, the cooling power is short.

When these are viewed based upon the relation between the quantity of air and the revolution shown in FIG. 3, the operation may be continued in case a predetermined revolution 2700 rpm in the steady operation of the pump 6 with a few. bubbles exceeds the revolution N1 when air of approximately 23 cc is mixed, however, caution is required. Besides, as an air lock is caused when air of 24 cc is mixed to be in an overheated state, FIG. 3 shows that it is desirable to keep the security of the computer that electrification to CPU 2 is stopped at the revolution N2 when air of approximately 23.7 cc is mixed.

The configuration of the controller that executes the above-mentioned process for the liquid cooling device will be described below. As shown in FIG. 4, a reference number 21 denotes a controller which is formed by CPUs and a memory (not shown) and is one example of realizing a function for controlling the liquid cooling device; 21a denotes a rotational number detector formed by a counter for calculating the revolution by counting the pulses of a frequency generator signal (hereinafter called an FG signal) output from a DC motor 23 described later; 21b denotes CPU for comparing the revolution N detected by the rotational number detector 21a and the predetermined numbers of revolutions N1, N2 and determining a process; and 21c denotes CPU for generating a signal for informing in case it is desirable to give warning based upon the judgment of CPU 21b or avoiding.

A reference number 22 denotes the computer on which CPU 2 as an exothermic component is mounted; 22a denotes an oscillator that oscillates a clock of an operating frequency for operating CPU 2; and 22b denotes a storage in which programs loaded onto CPU 2 are stored. Besides, a reference number 23 denotes the DC motor that switches polarity using Hall element and drives; 24 denotes a motor drive for driving the DC motor 23; 25 denotes a display device for operating the liquid crystal display la; and 26 denotes a switching circuit for the shutdown of the computer 22. In addition, an interface with input means such as a keyboard and a mouse and an external storage is provided to the computer 22 though the interface is not shown.

In the controller 21, the rotational number detector 21a detects the revolution N of the DC motor 23 based upon the above-mentioned relation between mixed air and the revolution, CPU 21b compares the revolution N with the predetermined revolution N1 (the predetermined revolution lower than the revolution at which the exothermic component is overheated and still having a margin though caution is required) and continues the operation if N<N1. If N≧N1, CPU 21c instructs the display device 25 and the computer 22 to execute control for the display of a sentence, a pictograph and others for notice by a stored method, the lighting of a lamp or the change of an operation mode by changing the clock frequency of CPU. Then, CPU 21b compares N with the revolution N2 (the revolution which is lower than the revolution at which the exothermic component is overheated and at which electronic equipment is shut down), and powers off the computer 22 when N≧N2.

CPUs of the controller 21 are independent of CPU 2 of the computer 22 as shown in FIG. 4, however, CPU 2 of the computer 22 may also function as the controller 21 by storing programs for operating CPUs of the controller 21 in the storage 22b of the computer 22. At this time, the function for controlling the liquid cooling device is realized by only CPU 2 of the computer 22.

The rotational number detector may also count FG signals by CPU or may also count them by a counter formed by a discrete circuit, detects a value of current flowing in the pump or a voltage value by a current sensor or a voltage sensor, and may also replace the value with the revolution of the pump.

CPU 21b may be also made by using a comparator circuit instead of CPU.

Next, a procedure executed by the controller 21 of the liquid cooling device when the refrigerant of the liquid cooling device of the electronic equipment decreases will be described in detail referring to a flowchart shown in FIG. 5. As shown in FIG. 5, first, acquiring a signal which is output every time the motor is rotated by a predetermined angle, then detecting the revolution based upon a interval of the signal (Step 1). In case the pump is driven by the DC motor 23, an FG signal is a signal output every time the motor is rotated by the predetermined angle and the revolution N of the pump is calculated by detecting the FG signal.

Next, the revolution N is compared with the revolution N1 (Step 2), if N<N1, control is returned to the Step 1 and the operation is continued, in case N≧N1, (I) any of the following (1), (2) and (3) is displayed on the liquid crystal display of the electronic equipment and further, (II) clocks of CPU 2 are reduced to reduce the calorific value in case the electronic exothermic component is CPU 2 (Step 3). For the display described in (I), any of (1) a comment for urging replenishment, “REPLENISH REFRIGERANT”, (2) the information of failure and (3) the information of life (an available period) is displayed. In case the exothermic component is CPU 2, (I) and (II) can be simultaneously executed. Further, in case the electronic equipment is the computer 22, the display device 25 of the computer 22 and the liquid crystal display la can be used for display for a caution.

Next, the revolution N is compared with the revolution N2 (Step 4), if N<N1, control is returned to the Step 1 and the operation is continued, and in case N≧N2, the electronic equipment is powered off (Step 5).

In this embodiment, N1 is set to “1.05<N<1.2” and N2 is set to “1.4<N<1.6”.

An optimum operation mode can be controlled by storing a table corresponding to the revolution N in steady operation in the storage for set values of N1 and N2 and adapting N1 and N2 to the revolution N in the steady operation of the pump.

As described above, the liquid cooling device in the embodiment and the electronic equipment having the same can detect that the quantity of the refrigerant in the liquid cooling device is insufficient and can avoid the deterioration of the cooling power by the mixing of air and an overheated state of the exothermic component.

In this embodiment, the revolution as a criterion of judgment is N1 and N2, however, three or more numbers of revolutions may be also set so as to further precisely control the operation mode or for simple control, one may be also set

In the embodiments of the invention, the collapsible notebook-sized computer has been described, however, the invention is not limited to this and the liquid cooling device according to the invention can be used in a desktop type computer, a projector, an optical drive device, a disk drive device and others.

The invention can be applied to the liquid cooling device for electronic equipment for cooling an exothermic component such as CPU arranged inside the body, or electronic equipment having the liquid cooling device.

1. A liquid cooling device for an electronic equipment comprising:
a closed circulating passage for circulating a liquid refrigerant;
a pump operating at a predetermined revolution for circulating the refrigerant;
a cooler removing a heat from an exothermic component using the liquid refrigerant;
a radiator radiating the removed heat; and
a reserve tank reserving the refrigerant,
wherein a first set revolution is set to more than a revolution at which the pump is steadily operated;
the liquid cooling device is judged to continue operating in case the revolution of the pump is equal to or smaller than the first set revolution; and
a quantity of refrigerant is judged to be insufficient in case the revolution of the pump exceeds the first set revolution.

2. The liquid cooling device according to claim 1, wherein:
a second revolution is set at larger than the first revolution but smaller than a revolution at which the pump causes an air lock; and
the quantity of refrigerant is judged to be insufficient in case the revolution of the pump exceeds the first set revolution but is within a range of a predetermined revolution which is smaller than the second revolution.

3. The liquid cooling device according to claim 1, wherein an alert processing is executed in case the quantity of refrigerant is judged to be insufficient.

4. An electronic equipment having the liquid cooling device of claim 3, wherein the electronic equipment is capable of displaying on a display device; and
a warning is displayed on the display device in case the quantity of refrigerant is judged to be insufficient.

5. An electronic equipment having the liquid cooling device of claim 1, wherein a control for reducing a calorific value of the exothermic component is instructed so as to change an operation mode in case the quantity of refrigerant is judged to be insufficient.

6. The electronic equipment according to claim 5, wherein the exothermic component comprises a semiconductor integrated circuit; and
the control for reducing a calorific value of the exothermic component is a control for reducing an operating frequency of the semiconductor integrated circuit.

7. The electronic equipment according to claim 1, wherein a power source is turned off in case the revolution of the pump exceeds the second set revolution.

8. A liquid cooling device for an electronic equipment comprising:
a closed circulating passage for circulating a liquid refrigerant;
a pump operating at a predetermined revolution for circulating the refrigerant;
a cooler removing a heat from an exothermic component using the liquid refrigerant;
a radiator radiating the removed heat;
a reserve tank reserving the refrigerant; and
a judgment means,
wherein a first set revolution is set to more than a revolution at which the pump is steadily operated;
the judgment means judges that the operation is to be continued in case the revolution of the pump is equal to or smaller than the first set revolution; and
the judgment means judges that a quantity of refrigerant is insufficient in case the revolution of the pump exceeds the first set revolution.
